(19) United States
(12) Patent Application Publication
(10) Pub. No.: US 2025/0030071 A1
(43) Pub. Date: Jan. 23, 2025

(54) Battery Bank With a Safety Device and Method for Triggering the Safety Device

(71) Applicant: Bayerische Motoren Werke Aktiengesellschaft, Muenchen (DE)

(72) Inventors: Alexander ADAM, Muenchen (DE); Roland JUNG, Muenchen (DE); Sebastian SCHARNER, Tuerkenfeld (DE); Thomas WOEHRLE, Muenchen (DE)

(21) Appl. No.: 18/714,696

(22) PCT Filed: Nov. 23, 2022
(86) PCT No.: PCT/EP2022/083017

§ 371 Date: May 30, 2024

(30) Foreign Application Priority Data
Dec. 10, 2021 (DE) 10 2021 132 745.8

(51) Int. Cl. H01M 10/52; H01M 10/42; H01M 50/204

(52) U.S. Cl. CPC H01M 10/52; H01M 10/4228; H01M 10/425; H01M 50/204; H01M 2010/4271

(57) ABSTRACT

A battery bank includes a bank housing and at least one battery cell arranged in an interior of the bank housing. Each battery cell contains a sulfur-dioxide-based electrolyte. The battery bank has a safety device including a cleaning device with a fluid additive for neutralizing gaseous sulfur-dioxide-based electrolyte components.

### BACKGROUND AND SUMMARY

The present invention relates to a battery bank with a safety device and a method for triggering the safety device.

Electrochemical cells are of great importance in many technical areas. For example, electrochemical cells are often used for mobile applications, for example for the operation of laptops, ebikes, or mobile telephones. One advantage of electrochemical cells is that they can be connected to one another in series or in parallel to form batteries having a higher energy. Such batteries can be combined in a so-called battery bank and are also suitable, among other things, for high-voltage applications. For example, battery tanks can enable the electric drive of vehicles or can be used as a stationary energy storage device.

The term “electrochemical cell” is used hereinafter synonymously for all designations typical in the prior art for rechargeable galvanic elements, such as cell, battery, battery cell, accumulator, battery accumulator, and secondary battery.

An electrochemical cell is capable of providing electrons for an external circuit during the discharging process. Vice versa, an electrochemical cell can be charged by the supply of electrons during the charging process by means of an external circuit.

An electrochemical cell has at least two different electrodes, one positive electrode (cathode) and one negative electrode (anode). Both electrodes are in contact with a separator, which is an electrical insulator. A porous polyolefin separator, which is impregnated with a liquid electrolyte composition, is used in the prior art, for example. The separator spatially separates the two electrodes from one another and connects the two electrodes to one another in an ion-conducting manner.

The electrochemical cell used most commonly is the lithium-ion cell, also called a lithium-ion battery. Lithium-ion cells from the prior art typically have a compound anode, which very frequently comprises a carbon-based anode active material, typically graphitic carbon, which is generally coated with an electrode binder on a metallic copper carrier film. In general, the composite cathode comprises a cathode active material, such as a layered oxide, a binder, and an electrical conductive additive, which are applied, for example, to a rolled aluminum collector foil. The layered oxide very frequently comprises LiCoO₂ or LiNi_{1/3}Mn_{1/3}Co_{1/3}O₂.

Lithium-ion batteries typically have a liquid electrolyte composition which ensures the charge equalization between the cathode and the anode during the charging and discharging process. The current flow required for this purpose is achieved by the ion transport of a conductive salt in the electrolyte composition. In lithium-ion cells, the conductive salt is a lithium conductive salt (e.g., LiPF₆ or LiBF₄).

In addition to the lithium conductive salt, electrolyte compositions contain a solvent which enables a dissociation of the conductive salt and a sufficient mobility of the lithium ions. Liquid organic solvents are known from the prior art which consist of a selection of linear and cyclic dialkyl carbonates. In general, mixtures of ethylene carbonate (EC), dimethyl carbonate (DMC), diethyl carbonate (DEC), propylene carbonate (PC), and ethyl methyl carbonate (EMC) are used. The solvents mentioned here each have a specific stability range in which they operate stably under a given cell voltage. This range is also known as the voltage window. The electrochemical cell can run stably during operation in the voltage window. Upon an approach to the limits of the voltage window, an electrochemical oxidation or reduction of the components of the electrolyte composition takes place. Therefore, efforts are taken to use electrolytes which have a higher stability in relation to different cell voltages.

Therefore, lithium-ion batteries having an inorganic electrolyte based on the solvent sulfur dioxide represent a refinement of lithium-ion batteries having an organic electrolyte. Various approaches for stable electrolyte compositions based on sulfur dioxide are known in the prior art.

EP 1 201 004 B1 discloses a rechargeable electrochemical cell having an electrolyte based on sulfur dioxide. Sulfur dioxide is not added as an additive substance in this case, but rather represents the main component as the solvent for the conductive salt in the electrolyte composition. It is therefore intended to at least partially ensure the mobility of the lithium ions of the conductive salt, which cause the ion transport between the electrodes. In the proposed cells, lithium tetrachloroaluminate (LiAlCl₄) is used as a lithium-containing conductive salt in combination with a cathode active material made of a transition metal oxide, in particular an intercalation compound such as lithium cobalt oxide (LiCoO₂). Functioning and rechargeable cells are obtained by the addition of a salt additive, for example an alkali halide such as lithium fluoride, sodium chloride, or lithium chloride, to the electrolyte composition containing sulfur dioxide.

EP 2534719 B1 describes a rechargeable lithium battery cell having an electrolyte based on sulfur dioxide in combination with lithium ferrophosphate (LFP) as a cathode active material. Lithium tetrachloroaluminate was used as the preferred conductive salt in the electrolyte composition. It was possible to show a high electrochemical resistance of the cells in experiments using cells based on these components.

WO 2015/043573 A2 describes a rechargeable electrochemical battery cell having a housing, a positive electrode, a negative electrode, and an electrolyte which contains sulfur dioxide and a conductive salt, wherein at least one of the electrodes contains a binder selected from the group consisting of binder A, which consists of a polymer that is synthesized from monomeric structural units of the conjugated carboxylic acid or from the alkali metal, alkaline earth metal, or ammonium salt of this conjugated carboxylic acid or from its combination thereof, and binder B, which consists of a polymer that is based on monomeric styrene and butadiene structural units, or a mixture of binder A and B.

WO 2021/019042 A1 describes rechargeable battery cells having an active metal, a layered oxide as the cathode active material, and an electrolyte containing sulfur dioxide. Due to the poor solubility of many common lithium conductive salts in sulfur dioxide, a conductive salt of the formula M⁺[Z(OR)₄]⁻ was used in the cells, in which M represents a metal selected from the group consisting of alkali metals, alkaline earth metals, and a metal of the 12^{th} group of the periodic system, and R is a hydrocarbon radical. The alkoxy groups —OR are each bound by a single bond to the central atom, which can be aluminum or boron. In one preferred embodiment, the cells contain a perfluorinated conductive salt of the formula Li⁺[Al(OC(CF₃)₃)₄]. Cells consisting of the described components show a stable electrochemical performance in experimental studies. Moreover, the conductive salts, in particular the perfluorinated anion, have a surprising hydrolysis stability. Furthermore, the electrolytes are supposed to be oxidation stable up to an upper potential of 5.0 V. Furthermore, it was shown that cells having the disclosed electrolytes can be discharged or charged at low temperatures down to −41° C.

Furthermore, German patent application number 10 2021 118 811.3 (no prior publication) discloses a liquid electrolyte composition based on sulfur dioxide for an electrochemical cell. The electrolyte composition comprises the following components: A) sulfur dioxide; B) at least one salt, wherein the salt contains an anionic complex having at least one bidentate ligand. The counterion of the anionic complex is a metal cation, selected from the group consisting of alkali metals, alkaline earth metals, and metals of the 12^{th} group of the periodic system. The central ion Z of the complex is selected from the group consisting of aluminum and boron. The bidentate ligand forms a ring with the central ion Z and with two oxygen atoms bound to the central ion Z and the bridge radical, wherein the ring contains a continuous sequence of 2 to 5 carbon atoms. In addition, an electrochemical cell, in particular a lithium-ion cell, having the abovementioned electrolyte composition was proposed.

In addition, cells having an electrolyte based on sulfur dioxide are known from EP 3 703 161 A1, EP 2 227 838 B1, EP 2 742 551 B1, EP 3 771 011 A2, WO 2005/031908 A2, and WO 2014/121803 A1, to which reference is made here.

In case of a mechanical, electrical, or thermal defect of the battery cells, in particular of lithium-ion cells having an electrolyte composition based on sulfur dioxide, a cell opening and thus the release of electrolyte components from the cell can occur, in particular gaseous electrolyte components such as sulfur dioxide.

This disclosure is based on the object of preventing a passage of the electrolytes into the surroundings in the event of such damage to a cell having an electrolyte based on sulfur dioxide.

The object may be achieved according to the invention by a battery bank having a bank housing and a safety device and at least one battery cell having an electrolyte based on sulfur dioxide according to the independent claim.

Advantageous embodiments of the battery bank according to the invention are specified in the dependent claims, which can optionally be combined with one another.

The object may be achieved according to the disclosure by a battery bank having a bank housing and at least one battery cell, which is arranged in an interior of the bank housing and contains an electrolyte based on sulfur dioxide, wherein the battery bank has a safety device that comprises a cleaning device having a liquid additive for neutralizing or binding gaseous electrolyte components based on sulfur dioxide.

Environmental influences or internal factors can result in damage to the battery bank and thus a release of the electrolyte based on sulfur dioxide. After the release, the electrolyte at least partially enters the gas phase and accumulates in the form of gaseous electrolyte components in the atmosphere of the interior. The atmosphere of the interior is thus contaminated by the gaseous electrolyte components.

The technology is based on the basic concept of providing a battery bank having a safety device, which can extract the contaminated atmosphere of the interior from the gaseous electrolyte components on the basis of sulfur dioxide and thus clean it. According to the invention, the safety device comprises a cleaning device having a liquid additive. The additive is used to neutralize or bind the gaseous electrolyte components, in particular the sulfur dioxide, and thus prevent the passage of the electrolyte into the surroundings.

In the context of this disclosure, neutralization of the electrolyte is understood as a chemical neutralization which converts the electrolyte components into more chemically stable and non-toxic compounds.

The battery bank is preferably located in a vehicle and enables the electric drive of the vehicle. Of course, multiple battery tanks can also be installed in such a vehicle. The battery bank according to the disclosure is not restricted to mobile applications such as vehicles and can also be used for stationary operation. For example, the battery bank according to the disclosure can be used to store energy from solar installations and wind parks.

According to the disclosure, the battery bank comprises a bank housing, in the interior of which at least one battery cell is arranged, preferably multiple battery cells. The battery cells can be interconnected in the bank housing to provide a higher level of energy.

A battery cell is understood as an electrochemical cell having an electrolyte based on sulfur dioxide. The battery cell is preferably a lithium-ion cell.

The technology is not further restricted with respect to the electrolyte composition based on sulfur dioxide. Therefore, any electrolyte compositions based on sulfur dioxide that are known in the prior art can be used.

In particular, an electrolyte based on sulfur dioxide is understood as a liquid electrolyte composition that contains sulfur dioxide as a component. The sulfur dioxide can be present in the electrolyte composition in liquid, gaseous, or bound form or in a complex.

Suitable examples of such electrolyte compositions are known from EP 1 201 004 B1, EP 2534719 B1, WO 2015/043573 A2, WO 2021/019042 A1, EP 3 703 161 A1, EP 2 227 838 B1, EP 2 742 551 B1, EP 3 771 011 A2, WO 2005/031908 A2, and WO 2014/121803 A1, and from German patent application number 10 2021 118 811.3 (no prior publication), to which reference is made here.

In one variant of the technology, the cleaning device can be arranged outside the bank housing. The cleaning device is connected in terms of flow to the interior of the bank housing here.

The term “in terms of flow” is understood hereinafter in particular as a gas flow.

This arrangement offers the technical advantage that installation space or room is saved inside the bank housing. Because the cleaning device is moved outside the bank housing, the installation space can moreover be used for other technical devices inside the bank housing, such as further battery cells or battery management systems, or the battery bank can be designed to be more compact as a whole.

In another variant, the cleaning device can be arranged in the interior of the bank housing.

This variant in turn offers the advantage that an electrolyte released from a cell only has to cover a short distance to the cleaning device. The time until neutralization or binding of the sulfur dioxide can thus be significantly reduced. In this embodiment, a synergistic effect with the design of battery banks, which is compact in any case, additionally results. The more compact the bank is designed to be, accordingly the shorter the resulting distance of the gaseous electrolyte to the cleaning device. A compact design of the battery bank and housing inside the bank housing therefore improves the operation of the cleaning device.

In one aspect of the disclosure, the liquid additive comprises a base. The technology is not further restricted with respect to the base. In general, all bases typical in the prior art can be used for the additive.

For example, the base can be a porous natural lime.

The base is preferably selected from the group of carbonates, hydrogen carbonates, oxides, hydroxides, and organic amines or amides as well as combinations thereof.

In particular metal carbonates may be used as carbonates, preferably alkali and alkaline earth metal carbonates. Suitable examples of carbonates are barium carbonate, calcium carbonate, magnesium carbonate, potassium carbonate, sodium carbonate, and zinc carbonate as well as combinations thereof.

In particular metal hydrogen carbonates may be used as hydrogen carbonates, preferably alkali and alkaline earth metal hydrogen carbonates. Suitable examples of hydrogen carbonates comprise calcium hydrogen carbonate, magnesium hydrogen carbonate, barium hydrogen carbonate, strontium hydrogen carbonate, sodium hydrogen carbonate, and potassium hydrogen carbonate as well as combinations thereof.

In particular metal oxides can be used as oxides, preferably alkali and alkaline earth metal oxides. Suitable examples of oxides comprise lithium oxide, sodium oxide, potassium oxide, magnesium oxide, calcium oxide, strontium oxide, and barium oxide as well as combinations thereof.

In particular metal hydroxides may be used as hydroxides, preferably alkali and alkaline earth metal hydroxides. Examples of hydroxides comprise in particular lithium hydroxide, sodium hydroxide, potassium hydroxide, calcium hydroxide, barium hydroxide, strontium hydroxide, and zinc hydroxide as well as combinations thereof.

Furthermore, the additive may comprise water. The base is thus present in an aqueous solution. The base is preferably dissolved in the aqueous solution.

In another aspect of the technology, the aqueous solution is a solution saturated by the base. Due to the high base content, the saturated solutions have a particularly high ion concentration. The ion concentration (base concentration) preferably corresponds to the solubility product of the respective base. Because of this, the solutions also remain liquid below the freezing point of water. The saturated solutions are therefore suitable in particular for operation or use in a vehicle.

The additive particularly preferably comprises a saturated aqueous solution of sodium carbonate, furthermore preferably an aqueous solution of potassium carbonate or combinations thereof.

The provision of a base in an aqueous solution enables the chemical neutralization of the electrolyte based on sulfur dioxide in the form of an acid-base neutralization. The sulfur dioxide contained in the electrolyte dissolves particularly well in water and can therefore be absorbed particularly efficiently by the additive. The solubility of sulfur dioxide in water is 112.7 g/L at 20° C. in this case. Sulfur dioxide reacts in water to form sulfurous acid, which can in turn react in a chemical neutralization reaction with the present base. The base can therefore convert the sulfur dioxide dissolved in the aqueous solution, in particular in the form of sulfurous acid, into more stable and non-toxic chemical compounds. For example, the carbon dioxide can be converted by carbonates into stable sulfites, sulfates, and/or hydrogen sulfites.

In addition, the base used may be non-toxic, well soluble in water, and easily available. Moreover, the base in an aqueous solution represents a liquid which may be stored and handled cost-effectively.

In another aspect of the technology, the cleaning device may comprise at least one reactor having the liquid additive. The reactor may have a gas inlet and a gas outlet, which are connected in terms of flow to the interior of the bank housing. Moreover, the gas inlet may have a diffuser element for converting gaseous electrolyte components into the liquid additive.

Such a reactor is also known as a gas scrubber reactor. The reactor can be embodied as a storage container, stainless steel autoclave, Teflon autoclave, or another container which is suitable for carrying out a chemical neutralization reaction.

The diffuser element at the gas inlet of the reactor may be used for better atomization and distribution of the gaseous electrolyte components entering the reactor. The diffuser can be embodied as a frit, for example, in particular a frit consisting of a porous glass or a porous ceramic.

Due to the atomization of the gaseous electrolyte components, the largest possible contact surface can be created between the electrolyte and the liquid additive. In this way, the reaction speed between the electrolyte and the liquid additive can be significantly increased. Moreover, diffuser elements are cost-effective, chemically stable, and easily available.

In a further aspect of the technology, several of the abovementioned reactors may be connected in series. In principle, arbitrarily many gas reactors can be connected in succession. The connection between the individual reactors can be produced via normal lines as long as they are chemically inert with respect to the liquid additive used and the gaseous electrolyte components based on sulfur dioxide.

Gaseous electrolyte components located in a reactor and not neutralized can pass through a further neutralization or be bound during the passage of the next reactor. The sequential concatenation of multiple reactors therefore offers the technical advantage that a chemical neutralization or a binding of the electrolyte components can take place particularly efficiently and completely.

In addition, at least one empty reactor without the liquid additive can be arranged between the individual reactors or after the reactors. Such a reactor, also called a safety reactor, enables the liquid additive to be captured if a pressure drop begins. The liquid additive is typically redirected from one reactor into another in the event of a pressure drop by negative pressure. To prevent the liquids from mixing in the reactors or the liquid from reaching the bank housing, such safety reactors can be used.

In a further aspect, the cleaning device may comprise a circulation pump that connects the gas inlet of the reactor to the interior of the bank housing in terms of flow. Due to the provision of a circulation pump, the atmosphere inside the bank housing can be actively guided via the gas inlet into the reactor. This offers the advantage in particular that a large gas volume can be guided into the reactor in a short time.

Moreover, the circulation pump can ensure a gas circulation inside the bank housing. Better mixing of the atmosphere in the bank housing can take place in this way and the electrolyte components located in the atmosphere may come into contact with the liquid additive in the reactor faster and more frequently.

In a further embodiment, the cleaning device can comprise a gas recirculation device, which connects the outlet of the reactor to the interior of the bank housing in terms of flow.

The gas recirculation device can comprise, for example, a pressure regulating valve or a switchable valve which releases the gas outlet from a specific overpressure inside the reactor, so that a purified atmosphere of the reactor is returned into the bank housing.

In a further variant, the gas recirculation device can comprise a further circulation pump which guides the electrolyte components guided through the reactor actively back into the bank housing.

In another aspect of the technology, the safety device may further comprises a monitoring unit that comprises a battery supervision system and a sensor unit connected to the battery supervision system.

The battery supervision system is preferably arranged outside the battery bank. It is therefore conceivable that the battery supervision system monitors multiple battery tanks. The sensor unit, which is preferably arranged inside the bank housing, is connected to the battery supervision system.

In one preferred embodiment, the sensor unit is selected from the group consisting of optical sensors, pressure sensors, temperature sensors, and chemical sensors.

In one particularly preferred embodiment, the sensor unit is a spectroscopic gas sensor for detecting gaseous sulfur dioxide.

In one very particularly preferred embodiment, the spectroscopic gas sensor is a nondispersive infrared sensor.

If abnormal behavior of at least one battery cell occurs during the battery operation, this can be detected by the abovementioned sensor types. A rise of the pressure or the temperature or a change of the atmospheric composition in the interior of the bank housing can therefore be detected by the sensor unit. A defect at a battery cell can thus be detected directly and without delay.

In particular a gas sensor responding selectively to sulfur dioxide enables direct information about the presence of sulfur dioxide inside the bank housing. If the gas sensor registers sulfur dioxide in the atmosphere of the bank housing, the electrolyte based on sulfur dioxide has escaped from the battery cell and the corresponding cell is therefore defective.

The data registered by the sensor unit are passed on to the active battery supervision system connected to the sensor unit. The data sent to the battery supervision system are typically measurement data which were collected in a specific time interval.

In a further aspect of the technology, the battery supervision system is provided for the purpose of receiving data from the sensor unit and evaluating these data with respect to a trigger or non-trigger scenario.

The battery supervision system receives the data of the sensor unit and evaluates these data with respect to the presence of a defect of a battery cell inside the bank housing. The battery supervision system decides on the basis of the data about whether to trigger a trigger scenario or a non-trigger scenario. If the battery supervision system registers abnormal data, more precisely data which deviate from the data to be expected, the battery supervision system thus may initiate a trigger scenario. If the data received from the sensor unit correspond to the data to be expected, a non-trigger scenario may be selected.

Upon the presence of a trigger scenario, the cleaning device may be actuated by the battery supervision system so that the circulation pump is activated, which suctions out the contaminated atmosphere present in the interior of the bank housing and introduces it into the reactor. The gaseous electrolyte components located in the atmosphere may be neutralized by the liquid additive located in the reactor and the purified atmosphere may be guided back into the bank housing.

In the case of a non-trigger scenario, the status quo may be maintained and the cleaning device is not actuated.

The above-described process preferably takes place at regular time intervals. The monitoring unit can thus monitor the battery cells in real time, due to which abnormal data such as pressure, temperature, and atmospheric parameters inside the bank housing can be registered promptly and reliably. The battery monitoring system can therefore also take measures promptly in order to introduce the gas atmosphere into the reactor having the liquid additive inside the battery bank.

A safety device according to this disclosure, which may include the monitoring unit and the circulation pump electrically connected to the monitoring unit, may therefore be an active safety system. The safety device may therefore be capable of actively initiating countermeasures in case of an electrolyte escaping from a cell.

Furthermore, the technology relates to a method for triggering a safety device for a battery bank of the above type, wherein the method may comprise the following steps:
a) detecting an escape of the electrolyte from a battery cell inside the bank housing by way of the sensor unit of the monitoring unit,
b) compiling data by way of the sensor unit and passing on the data to the battery supervision system,
c) evaluating the data by way of the battery supervision system with respect to the presence of a trigger or non-trigger scenario,
d) detecting a trigger scenario, and
e) triggering the safety device by actuating the cleaning device, so that the circulation pump and optionally the gas recirculation device is activated, by which the atmosphere of the interior is guided into the reactor, purified in the reactor, and optionally fed back to the bank housing.

A safety device which operates according to the above-mentioned methods can therefore react promptly to an electrolyte escaping from a battery cell and take countermeasures. The electrolyte based on sulfur dioxide may therefore be reliably prevented from passing into the surroundings.

The invention is described in more detail hereinafter on the basis of drawings with reference to the appended drawings.

### BRIEF DESCRIPTION OF THE DRAWINGS

FIG. 1 shows a schematic representation of a battery bank in the case of a non-trigger scenario having a safety device;

FIG. 2 shows a schematic representation of the battery bank from FIG. 1 in the case of a trigger scenario;

FIG. 3 shows a gas sensor for selective detection of sulfur dioxide in the battery bank;

FIG. 4 shows a schematic representation of a suitable measurement range for a gas sensor from FIG. 3; and

FIG. 5 shows a schematic flow chart of the steps for triggering a safety device for an upstream battery bank.

### DETAILED DESCRIPTION OF THE DRAWINGS

FIG. 1 shows a battery bank 10 having a safety device 12, 38.

The battery bank 10 furthermore comprises a bank housing 4.

The bank housing 4 has an interior 6, in which at least one battery cell 2 is arranged. However, multiple battery cells can also be arranged in the interior 6. Moreover, an arrangement of the battery cells 2 inside the bank housing 4 can be arbitrary. If multiple battery cells 2 are present, they can be interconnected (not shown here) to provide a higher energy level of the battery bank 10.

The battery cells 2 contain at least one electrolyte based on sulfur dioxide. The technology is not further restricted in general with respect to the battery cell 2 as long as the battery cell contains sulfur dioxide as an electrolyte component.

For example, battery cells 2 having an electrolyte composition from WO 2021/019042 A1, WO 2015/043573 A2, or German patent application 10 2021 118 811.3 (no prior publication) can be used.

The safety device 12, 38 comprises a cleaning device 12 and a monitoring unit 38. The cleaning device 12 and the monitoring unit 38 are connected to one another via at least one electrical connection 28, wherein electrical signals can be transmitted and received via the connection 28.

The cleaning device 12 is arranged outside the bank housing 4 and comprises at least one reactor 14 as the central component. As is apparent from FIG. 1, two reactors 14 are present in the embodiment shown.

The reactor 14 comprises a reactor housing 11, which encloses an elongated cylindrical reactor chamber 17, wherein the cylindrical reactor chamber 17 has a longitudinal direction. Moreover, the reactor chamber 17 has two ends arranged opposite to one another on the long side, which delimit the reactor chamber 17 in the longitudinal direction. One end has a gas outlet 22 that is connected to the reactor chamber 17 in a gas-permeable manner. The other end has a gas inlet 18, which is also connected to the reactor chamber 17 in a gas-permeable manner.

Furthermore, the reactor has a preferably liquid-tight or liquid-repellent, gas-permeable diffuser element 34, which is arranged proximally in the reactor housing 11. The diffuser element is, for example, a frit consisting of a porous glass or a porous ceramic. The diffuser element 34 can optionally be provided with a hydrophobic surface coating (not shown here) in the direction of the gas outlet 22. Hydrophobic materials such as siloxanes or waxes are suitable as the coating materials.

The diffuser element 34 divides the reactor chamber 17 into a pressure chamber 15 and a reaction chamber 13. The pressure chamber 15 faces toward the gas inlet 18, while the reaction chamber 13 faces away from the gas outlet 22. Moreover, the reaction chamber 13 comprises a larger volume than the pressure chamber 15. In other words, the diffuser element 34 separates the reaction chamber 13 from the pressure chamber 15, but connects these to one another in a gas-permeable manner.

The reaction chamber 13 is thus delimited in the longitudinal direction by the gas outlet 22 and by the diffuser element 34 and laterally by the reactor housing 11. The pressure chamber 15 is delimited in the longitudinal direction by the diffuser element 34 and by the gas outlet 22 and laterally by the reactor housing 11.

A liquid additive 8 is located in the reaction chamber 13.

The liquid additive 8 may comprise at least one base, which is present in an aqueous solution, wherein the base is selected from the group of carbonates, hydrogen carbonates, oxides, hydroxides, and organic amines or amides as well as combinations thereof.

The reactor 14 is connected to the bank housing 4 in terms of flow. The term “in terms of flow” is understood hereinafter in particular as a gas flow.

The bank housing 4 therefore has an outflow opening 20, which is incorporated in a wall of the bank housing 4. The outflow opening 20 is closed by a gas outlet device 16.

The gas outlet device 16 is configured to release the outflow opening 20 from a specific overpressure in the interior 6 of the bank housing 4 or upon receiving an electrical signal.

The gas outlet device 16 comprises, for example, a switchable pressure regulating valve.

A feed line 26 extends from the outflow opening 20 to a circulation pump 36. In particular, the feed line 26 connects the circulation pump 36 in terms of flow to the interior 6 of the bank housing 4.

In addition, a further feed line 26 extends from the circulation pump 36 to the gas inlet 18 of the reactor 14. The pressure chamber 15 of the reactor 14 is therefore connected in terms of flow to the interior 6 of the bank housing 4.

Furthermore, the gas outlet 22 of the reactor 14 has a connecting line 25, which connects the reactor 14 to a second reactor 14 in terms of flow. In particular, the connecting line 25 connects the reaction chamber 13 of the first reactor 14 to the pressure chamber 15 of the second reactor 14.

The second reactor 14 has the same structure as the first reactor 14.

The gas outlet 22 of the second reactor 14 is in turn connected in terms of flow using a return flow line 30 to a gas recirculation device 37.

The gas recirculation device 37 is incorporated in a wall of the bank housing 4 and closes a return flow opening 29. The gas recirculation device 37 is configured to release the return flow opening 29 in the bank housing 4 upon a specific overpressure within the return flow line 30 or upon receiving an electrical signal, so that the second reactor 14 is connected in terms of flow to the interior 6 of the bank housing 4.

Furthermore, the safety device 12, 38 has a monitoring unit 38.

The monitoring unit 38 comprises a battery supervision system 35, which has a sensor unit 32 connected to the battery supervision system 35. The sensor unit 32 is arranged inside the bank housing 4. The arrangement of the sensor unit 32 in the interior 6 of the bank housing 4 can be arbitrary. For example, the sensor unit 32 can be fixed on an inner wall of the bank housing 4. However, the sensor unit 32 can also be fastened directly on a battery cell 2.

In one variant of the technology, multiple sensor units 32 can also be arranged at arbitrary points inside the bank housing 4. Various areas of the battery bank 10 can therefore be sensorially monitored by the sensor unit 32.

In general, the battery supervision system comprises electrical connections 28 to the circulation pump 36, the gas outlet device 16, the sensor unit 32, and the gas recirculation device 37. The electrical connections 28 are designed to transmit electronic signals.

The technology is not further restricted with respect to the sensor unit 32. Any sensor units known in the prior art can be used, which are suitable for detecting a difference in pressure, temperature, or atmosphere.

The sensor unit 32 is preferably a sensor for selective detection of sulfur dioxide, preferably gaseous sulfur dioxide in an atmosphere. Any sensors known in the prior art can be used for this purpose.

For example, an indicator known from U.S. Pat. No. 4,222,745 for detecting outflowing sulfur dioxide from a battery can be used. This consists of potassium dichromate adsorbed on finely dispersed silicon dioxide and an adhesive polymer material, for example, polydimethyl siloxane as a stabilizing matrix. Furthermore, titanium dioxide can be added for more intensive color perception. This indicator changes its color upon contact with sulfur dioxide.

A detector known from WO 02 079 746 is also conceivable, consisting of powdered potassium dichromate, which is applied on an adhesive strip together with an oxidation accelerator and a metal oxide inhibitor, which enables the detection of sulfur dioxide, inter alia.

A sensor is also known from U.S. Pat. No. 6,579,722 for detecting gaseous sulfur dioxide, in which a chemiluminescent reagent is immobilized in a polymer film. The chemiluminescence due to the contact with sulfur dioxide is detected with the aid of a photomultiplier or a photoelectric element.

A sensor from JP 2003035705 can also be used, which is suitable for sulfur dioxide detection of a gaseous sample, in which the optical transmission in the UV/VIS/IR range under the effect of the analyte is tracked. The sensor consists of a combination of orange-1 and amines and a combination of iron ammonium sulfate, phenanthroline, and acids.

A sensor is also known from EP 0 585 212, which is embodied as a sensor membrane for detecting sulfur dioxide. For this purpose, transition metal complexes having ruthenium, osmium, iridium, rhodium, palladium, platinum, or rhenium as the central atom, 2,2′-bipyridine, 1,10-phenanthroline, or 4,7-diphenyl-1,10-phenanthroline as ligands and perchlorate or chloride or sulfate as the counteranion are used. The polymer matrix originates from the group of cellulose derivatives, polystyrenes, polytetrahydrofurans, or their derivatives.

A sensor from EP 0 578 630 can also be used, which provides a sensor membrane of optical sensors for detecting sulfur dioxide. For this purpose, pH indicators, such as the fluorescent pigment quinine or the absorption pigment bromocresol purple are immobilized with counterions, such as long-chain sulfonate ions or ammonium ions having long-chain radicals, in a polymer matrix made of polyvinyl chloride.

An optical sensor for selective detection of gaseous sulfur dioxide is particularly preferably used.

For example, an optical sensor can be used as is known from “Optical sensors for dissolved sulfur dioxide” (A. Stangelmayer, I. Klimant, O. S. Wolfbeis, Fresenius J. Analytical Chemistry, 1998, 362, 73-76). To detect gaseous sulfur dioxide, lipophilic pH indicators in the form of ion pairs, which are immobilized in a gas-permeable silicone or OsmoSil membrane, are used as sulfur dioxide sensors for gaseous samples. In this case, ditetraalkylammonium salts with long-chain alkyl radicals of bromothymol blue, bromocresol purple, and bromophenol blue are used as pH indicators. The absorption of light in the UV/VIS range is used as the measured variable.

An optical sensor can also be used for the quantitative determination of sulfur dioxide in a sample, as is known from DE 10 2004 051 924 A1. The sensor proposed here contains an indicator substance immobilized homogeneously in a matrix of the transparent sensor, which comes into at least indirect contact with the sample and changes its concentration in the presence of sulfur dioxide. This concentration change of the indicator substance can be photometrically tracked as a change of the light transmission in the UV/VIS range of the sensor.

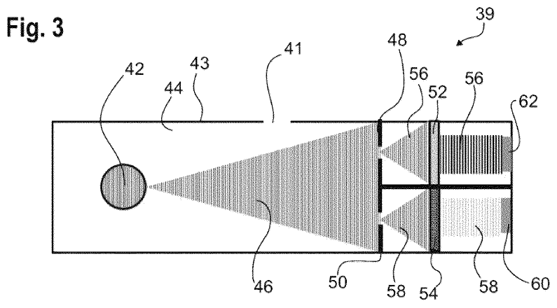

In one particularly preferred variant, the sensor for selective detection of sulfur dioxide is a sensor as described in FIG. 3.

The sensor unit 32 is configured to register an escape of the electrolyte from a battery cell 2, compile data therefrom and pass these data on to the battery supervision system 35. The data are transferred via an electrical connection 28.

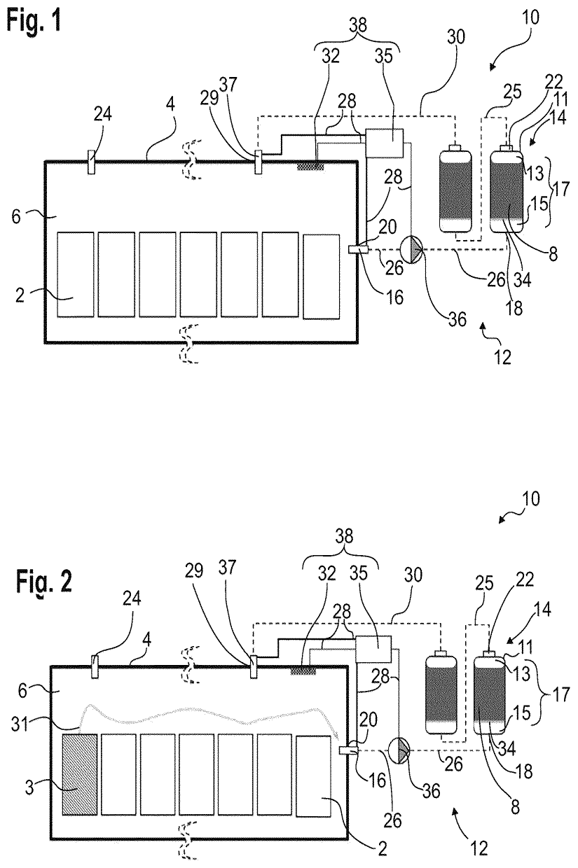

FIG. 2 shows the battery bank 10 from FIG. 1 in the case of a trigger scenario.

In addition, FIG. 2 contains the same components as already described in FIG. 1.

The mechanism of a trigger scenario will be described hereinafter on the basis of FIG. 2.

In the case of an electrical, thermal, or chemical defect of a battery cell 2, among other things, a cell opening of the affected cell 2 can occur. Such a battery cell 2 is thus a defective cell 3 from which gaseous electrolyte components 31 are released into the interior 6. However, damage to a cell 2 can also occur without a cell opening taking place in parallel. In both cases, however, a parameter in the interior 6 of the bank housing 4 will necessarily change, such as temperature or pressure or atmospheric composition. A change of this parameter is registered by sensor unit 32.

In the case of a cell opening of a defective cell 3, the electrolyte can enter the interior of the bank housing 4 either in liquid or in gaseous form. The case of gaseous electrolyte components 31 is shown in FIG. 2. These are registered by the sensor unit 32. The sensor unit 32 registers the presence of such an electrolyte in the form of deviating parameters, as already described above. These are passed on as abnormal parameters in the form of data to the battery supervision system 35.

The battery supervision system 35 continuously compares the received data to the data to be expected. If a predefined deviation of the received data from the data to be expected is established, the battery supervision system 35 thus triggers a trigger scenario.

The battery supervision system 35 thereupon activates the circulation pump 36 and opens the outflow opening 20 through the gas outlet device 16. Moreover, the battery supervision system 35 actuates the gas recirculation device 37, so that the return flow opening 29 is released.

The circulation pump 36 guides the atmosphere, which is present in the interior 6 of the bank housing 4 and is contaminated with gaseous electrolyte components 31, into the feed line 26 and thus to the gas inlet 18 and into the pressure chamber 15.

The discharged atmosphere of the interior 6 is stored in the pressure chamber 15. An overpressure builds up with time in the pressure chamber 15. The overpressure can also be specified by the circulation pump 36. From a predetermined overpressure, the atmosphere present in the pressure chamber 15 can pass via the diffuser element 34 into the reaction chamber 13. In this case, the diffuser element 34 atomizes the atmosphere, so that a larger contact surface to the liquid additive 8 present in the reaction chamber 13 is obtained. A chemical neutralization reaction takes place in the reaction chamber 13 between the gaseous electrolyte components in the contaminated atmosphere and the liquid additive 8.

The contaminated atmosphere of the bank housing 4 can be cleaned by the neutralization or binding of the sulfur dioxide taking place in the reaction chamber 13 and can pass via the gas outlet 22 and the connecting line 25 into the second reactor 14. Renewed purification of the atmosphere takes place here, as already explained for the first reactor 14.

The atmosphere, which is nearly completely purified after passing through the second reactor 14, can pass via the return flow line 32 to the the gas recirculation device 37 and thus enter the interior 6 of the bank housing 4 again.

FIG. 3 shows a sulfur dioxide sensor based on a two-beam spectrometer.

The gas sensor 39 has a detector chamber 44 enclosed by a detector housing 43. In addition, the detector housing 43 has a gas entry opening 41.

The gas entry opening 41 connects the detector chamber 44 in terms of flow to the interior 6 of the bank housing 4. A free gas exchange can thus take place between the two areas and an escaping electrolyte in the bank housing 4 can be registered by the gas sensor 39.

The detector housing 43 may have an elongated shape, wherein a light source 42 is assigned to one end inside the housing 43.

The light source 42 is preferably an infrared light source, particularly preferably a near-infrared light source. The technology is not restricted with respect to the infrared light source. Any IR light sources known in the prior art can be used as long as they can emit wavelengths which are suitable for detecting sulfur dioxide in a gas atmosphere.

The light source 42 preferably emits wavelengths in the range between 400-1800 cm⁻¹, particularly preferably between 450-600 cm⁻¹, 1100-1200 cm⁻¹, and/or 1300-1400 cm⁻¹. In operation, the light source 42 may emit an NIR beam 46 having a continuous spectrum of the wavelengths in the abovementioned range.

The NIR beam 46 emitted by the light source 42 may be split by a measurement beam aperture 48, arranged in the detector chamber 44, and a reference beam aperture 50 into two NIR beams spatially separated from one another. More precisely, the NIR beam 46 may be split by the measurement beam aperture 48 into a measurement beam 56 and by the reference beam aperture 50 into a reference beam 58. Two separate beam paths may thus be generated by the apertures.

After passing through the measurement beam aperture 48, the measurement beam 56 may be incident on a measurement beam filter 52. After passing through the reference beam aperture 50, the reference beam 58 may be incident on a reference beam filter 54.

Suitable measurement beam filters 52 and the reference beam filter 54 are, for example, bandpass filters, preferably narrowband filters. For example, the bandpass filter can have a bandwidth of 10-0.2 nm, preferably 5-0.2 nm, particularly preferably 2-0.2 nm. These are thus capable of selectively filtering out a predetermined wavelength from the reference beam 58 and the measurement beam 56.

As a reference, the transmission range of the reference beam filter 54 may be selected so that it is transmissive in a narrow range of the spectrum in which neither sulfur dioxide nor other molecules, such as carbon dioxide, have absorption bands.

For the measurement beam filter 52, thus that of the measurement beam 56, the transmission range may be selected so that it falls in a range where only sulfur dioxide absorbs, but no other gases, which could corrupt the measurement signals.

Examples of suitable wavelengths of the measurement beam filter 52 are: 1.56 μm, 1.57 μm, 1.58 μm, 2.46 μm, and 4.02 μm.

After passing through the measurement beam filter 52, the measurement beam 56 may be incident on a measurement beam detector 62 downstream from the measurement beam filter 52. Similarly, the reference beam 58 may be incident on a reference beam detector 60 downstream from the reference beam filter 54.

Detectors based on thermocouples, for example, are suitable for detecting the wavelengths transmitted through the filters. These are capable of converting thermal energy directly into electrical energy, by which very small thermal voltages can be generated and therefore registered. The detectors used thus operate particularly precisely and may also be suitable for detecting small quantities of sulfur dioxide in an atmosphere.

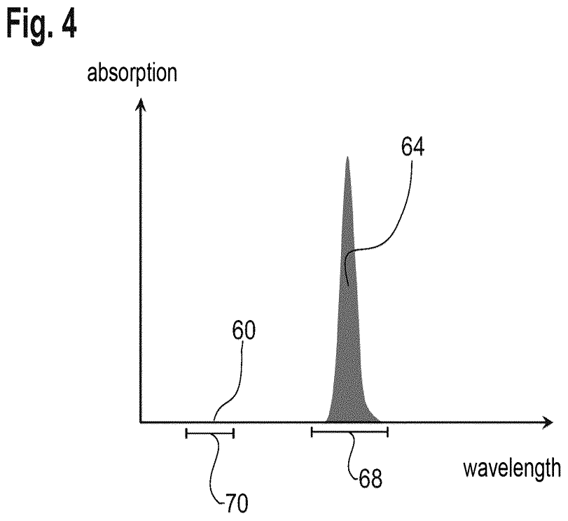

FIG. 4 shows a measurement range of a sulfur dioxide sensor from FIG. 3, wherein absorption is plotted in relation to a wavelength. The summed absorption of the measurement beam and the reference beam detectors 60, 62 is shown.

The measurement beam detector 62 registers the measurement signal 64 in a measurement wavelength range 68, while the reference beam detector 60 registers the reference signal 66 in a reference wavelength range 70. The reference wavelength range 70 and the measurement wavelength range 68 are predetermined by the selection of the beam filters. The width of the measured wavelength ranges is also dependent on the selection of the beam filter and is generally 10-0.2 nm, preferably 5-0.2 nm, particularly preferably 2-0.2 nm.

If the measurement beam detector 62 registers a measurement signal 64, sulfur dioxide is present in the atmosphere of the detector chamber 44 and therefore also in the interior 6 of the bank housing 4. For a positive sulfur dioxide detection, a threshold value can be defined, which typically lies above the background noise of the detector.

The advantage of the two-beam spectrometer shown is that it may be housed compactly and thus in a space-saving manner inside the bank housing 4. Moreover, sulfur dioxide is registered spectroscopically, due to which the evaluation and conversion into items of electronic information is facilitated in relation to conventional methods.

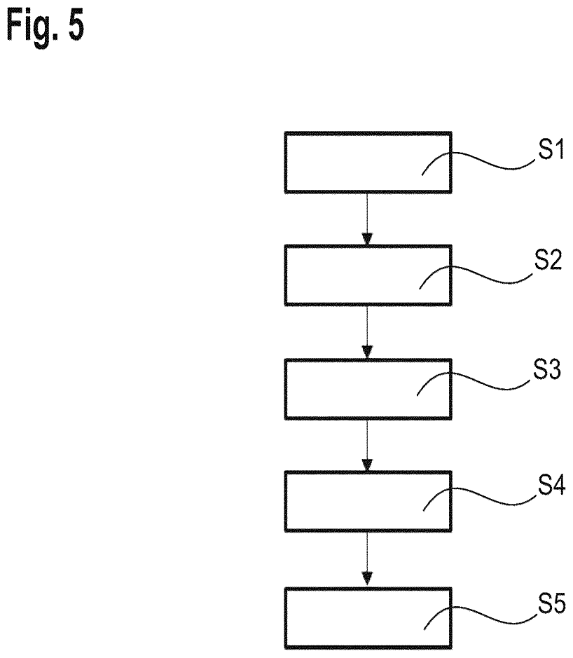

FIG. 5 shows a schematic flow chart of the steps of a method for triggering a safety device for a preceding battery bank 10.

In the first step, the sensor unit detects an escaping electrolyte from a battery cell inside the bank housing (step 1).

The sensor unit compiles data from this event and passes these data on to the battery supervision system (step 2).

The battery supervision system then assesses the data with respect to the presence of a trigger or non-trigger scenario (step 3).

If a trigger scenario is present after assessment of the data, the battery supervision system thus detects a trigger scenario (step 4).

In the last step, the safety device triggers the trigger scenario by the actuation of the cleaning device, so that the circulation pump and optionally the gas recirculation device are activated, by which the atmosphere of the interior is guided into the reactor, purified in the reactor, and optionally supplied back to the bank housing (step 4). The actuation of the individual components of the cleaning device takes place via the battery supervision system.

1-10. (canceled)

11. A battery bank comprising:
a bank housing and one or more battery cells positioned in an interior of the bank housing, each battery cell containing an electrolyte based on sulfur dioxide; and
a safety device including a cleaning device having a liquid additive for neutralizing gaseous electrolyte components based on sulfur dioxide.

12. The battery bank according to claim 11, wherein
the cleaning device is positioned outside the bank housing.

13. The battery bank according to claim 11, wherein
the liquid additive comprises at least one base present in an aqueous solution.

14. The battery bank according to claim 13, wherein
the base is selected from the group consisting of a carbonate, hydrogen carbonate, an oxide, a hydroxide, an organic amine, an amide, and combinations thereof.

15. The battery bank according to claim 11, wherein
the cleaning device comprises a reactor having the liquid additive, wherein the reactor has a gas inlet and a gas outlet connected to the interior of the bank housing in terms of flow.

16. The battery bank according to claim 15, further comprising a diffuser element positioned at the gas inlet for transferring gaseous electrolyte components into the liquid additive.

17. The battery bank according to claim 15, wherein
a plurality of the reactors are connected in series.

18. The battery bank according to claim 15, wherein
the cleaning device further comprises a circulation pump connecting the gas inlet of the reactor to the interior of the bank housing in terms of flow.

19. The battery bank according to claim 15, wherein
the cleaning device further comprises a gas recirculation device connecting the gas outlet of the reactor to the interior of the bank housing in terms of flow.

20. The battery bank according to claim 11, wherein
the safety device has a monitoring unit comprising:
a battery supervision system; and
a sensor unit connected to the battery supervision system, wherein
the sensor unit is configured to register an escape of the electrolyte from any of the one or more battery cells, to compile data therefrom and pass these data onto the battery supervision system, and
the battery supervision system is configured to receive the data from the sensor unit and evaluate these data with respect to a trigger or non-trigger scenario.

21. The battery bank according to claim 20, wherein
the battery supervision system is further configured, in the event of the trigger scenario, to actuate the cleaning device to activate a circulation pump.

22. The battery bank of claim 21, wherein the circulation pump is configured to:
suction out gaseous electrolyte components present in the interior of the bank housing and introduce them into the reactor for neutralization by the liquid additive, and
a conduct a purified gas back into the bank housing.

23. A method for triggering a safety device for a battery bank, the method comprising:
providing the battery bank according to claim 20;
detecting, by way of the sensor unit of the monitoring unit, an escape of the electrolyte from any of the one or more battery cells inside the bank housing;
compiling data, by way of the sensor unit, and passing the data on to the battery supervision system;
evaluating the data, by way of the battery supervision system, with respect to the presence of a trigger or non-trigger scenario,
upon detecting a trigger scenario, actuating the cleaning device to trigger the safety device, whereby the circulation pump is activated to direct an atmosphere of the interior of the bank housing into the reactor for purification.

24. The method of claim 23, further comprising activating the gas recirculation device upon detecting the trigger scenario, whereby the atmosphere of the interior of the bank housing is delivered back to the bank housing after purification.
